(19) United States
(12) Patent Application Publication
(10) Pub. No.: US 2005/0232076 A1
(43) Pub. Date: Oct. 20, 2005

(54) Micromixer with overlapping-crisscross entrance

(76) Inventors: Jing-Tang Yang, Hsinchu (TW); Lilin Wang, Kaohsiung City (TW); Ker-Jer Huang, Longtan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/107,775

(22) Filed: Apr. 18, 2005

(30) Foreign Application Priority Data
Apr. 19, 2004 (TW) 093110795

(51) Int. Cl. B01F 5/06

(52) U.S. Cl. 366/336; 366/340; 366/DIG. 3

(57) ABSTRACT

The micromixer with overlapping-crisscross entrance incorporated with the grooved microchannel, is used effectively for mixing two or more fluid streams. The X-shape overlapping-crisscross inlet ports wherein two microfluidic channels contact over a small area, allow the fluid streams flow through and create the tumbling inside the micromixer. Then merging with some patterned grooves on the walls also induces swirling motion. As a result, the folding and stretching effects of the flow are augmented to amplify the fluid mixing of two or more streams of the inlet fluids within a relative short distance in the micromixer. All of the flow streams are actuated with either pressure driven by a syringe pump or capillary electrophoresis. The present invention is applicable for micro total analysis systems and drug delivery systems.

### BACKGROUND OF THE INVENTION

1. Field of the Invention

The present invention relates to a micromixer. More specifically, the present invention discloses a micromixer with overlapping-crisscross entrance in which the fluid streams flow through and create the tumbling.

2. Description of the Prior Art

For improving the biochemistry or the medical diagnosis effectively many countries actively invest in bio chip field in recent years, including a micro total analysis system (μ-TAS), which is a combination of micro accurate fabricating, biomedicine and photoelectric technologies.

In comparison of traditional biochemistry diagnostic procedure that is tedious and time consuming, the key of developing this kind of inspection chip lies in only the trace of the body for a succession of transport, distribution, mix, separating, and extracting for examining. It has advantages of fast, parallel dealing with and environmental protection concurrently.

Generally speaking, the biochip is classified into micro array and lab-on-a-chip, and micromixer is quite important in the ring of researching and developing for lab-on-a-chip.

FIG. 1 is a micromixer of U.S. patent 2002/645784, which composed of two wave-type fluid microchannels without actuator. It uses the design in which two fluids flow and are crossed and divided in nodes of microchannels by folding and stretching for mixing fluids quickly. The waveform designing and appearing of crossed microchannels in combined construction will repeatedly divide and cross fluids that flow through downstream to promote effective mixing.

However the flow in a regime of small Reynolds number is laminar, inertial forces are much smaller than viscous forces, and there is little macroscopic advection between fluid layers. This design often causes two fluids flow separately on both sides of microchannel, and only has slowly molecular diffusion between two fluids as a consequence of having difficulties to produce folding and stretching wanted.

Lacking the bulk mixing characteristics of macroscale systems, in which increased agitation or perturbation promotes effective mixing, the enhancement of fluid mixing in microscale systems remains a problematic challenge.

Additionally, in FIG. 2 the WIPO's patent WO03011443 is a passive micromixer, which has different geometric structure of grooves in the bottom of Y type microfluidics channel to generate the transverse momentum to the flows, and it does not need to utilize other active component. Because geometric grooves in the wall of microchannel causing the fluid transverse and spiral flow wherein flow has been folded and stretched, it produces the effect of chaotic trajectories and enhances mixing efficiency in passive micromixer. In order to cause the fluid flows transversely and spirally in microchannel, the different angle, type and structured grooves in the wall are used.

Because of the driven pressure when the fluid flows through groove's surface in microchannel, it produces the chaotic trajectories by lateral force and the effect of lateral diffusion to influence the fluid, and effectively shorten the distance of mixing. However, with the effect of entrance mechanism the fluid exposed to interfacial area has not obtained big advantage of it, and is unable to improve mixing efficiency further.

Furthermore, in FIG. 3A and 3B shows a perspective view and the flow pattern of staggered herringbone mixer (SHM), which resembles a letter “T” in that opposing fluid streams enter and merge at the inlet port, and leave from the channel in a perpendicular direction. The flow pattern of a SHM shows that the two collateral fluid streams flow into the mixing channel without generating transverse bulk motion until encountering the patterned grooves. Only negligible diffusion acts between the interfacial area of counter-impinging fluids, and the two fluids remain distinct.

Mixing fluids in a microfluidics system is difficult because of the small Reynolds number. Thus, under the laminar flow condition, mixing totally different fluids in a microscale channel is a very crucial technology, which offers fluids to go on besides diffusing, and widely increase the interfacial area among the molecules of fluid by overcoming different physico-chemical phenomena of fluid under micro space and the condition of low Reynolds number for passive micromixers without active component.

Therefore, there is need for Micromixer with Overlapping-Crisscross Entrance for mixing different fluids in microchannels to cope with the problem mentioned above.

### SUMMARY OF THE INVENTION

To achieve these and other advantages and in order to overcome the disadvantages of the conventional method in accordance with the purpose of the invention as embodied and broadly described herein, the present invention provides the micromixer with overlapping-crisscross entrance.

The present invention provides a micromixer with overlapping-crisscross entrance that merges two fluids and alters the flow motion of both at the entrance region and enlarges the contact area between the two mixing fluids and induces tumbling to generate a vertical component of flow.

Additionally, the present invention provides a micromixer with overlapping-crisscross entrance that develops a significant crossflow about the inlet port of the micromixer and grooved channels, thus improving the mixing performance near the inlet port

Furthermore, the present invention provides a micromixer with overlapping-crisscross entrance that activates a restructuring of the flow configuration and mixing patterns in the grooved microchannels.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an infrastructure of a micro mixer of the prior art;

FIG. 2 is a diagram illustrating an infrastructure of a passive micromixer of the prior art;

FIG. 3A is a perspective view of staggered herringbone mixer of the prior art;

FIG. 3B is the vertical distributed streaklines of flow patterns of staggered herringbone mixer of the prior art;

FIG. 4A is a schematic diagram illustrating the micromixer with overlapping-crisscross entrance according to an embodiment of the present invention;

FIG. 4B is the vertical distributed streaklines of flow patterns according to an embodiment of the present invention;

FIGS. 5A and 5B are row streaklines of the upper streams and lower streams according to an embodiment of the present invention;

FIG. 6 is turning ratios and mass flow rate ratios versus various initial flow rate ratios according to an embodiment of the present invention;

FIGS. 7A and 7B are bulk concentration contours according to an embodiment of the present invention and the staggered herringbone mixer;

FIG. 8 is mixing indexes at various longitudinal distances of x-direction and y-direction channels according to the SHM and an embodiment of the present invention;

FIG. 9 is the magnified image of the grooves according to FIGS. 7A;

FIG. 10 is an experimental image of concentration contour on cross sections along the z-axis according to an embodiment of the present invention;

FIG. 11 is an experimental image of flow visualization of mixing between (a) air and de-ionized water and (b) red and white water according to an embodiment of the present invention; and

FIG. 12 is a schematic diagram according to an embodiment of the present invention.

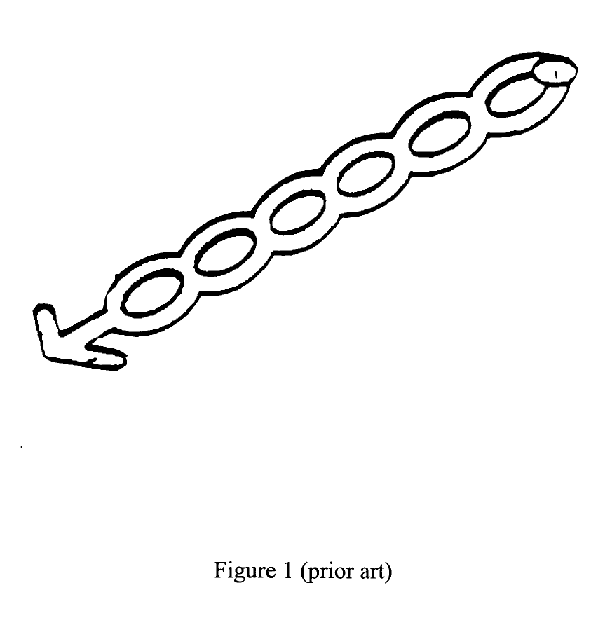

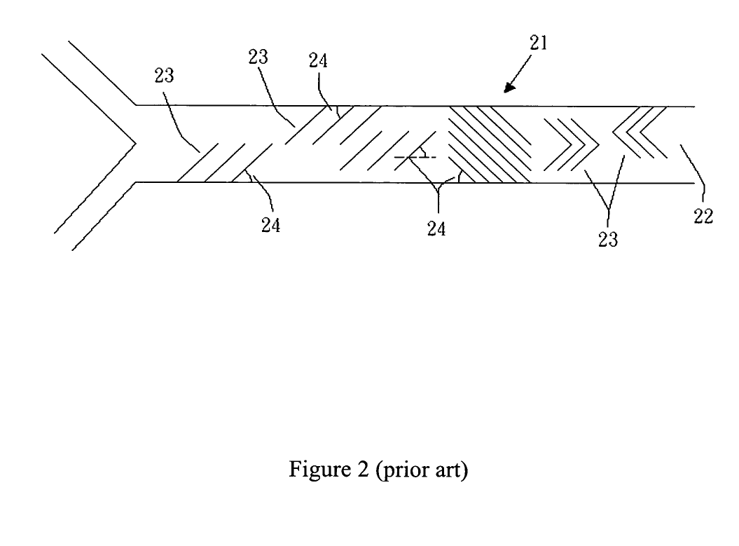

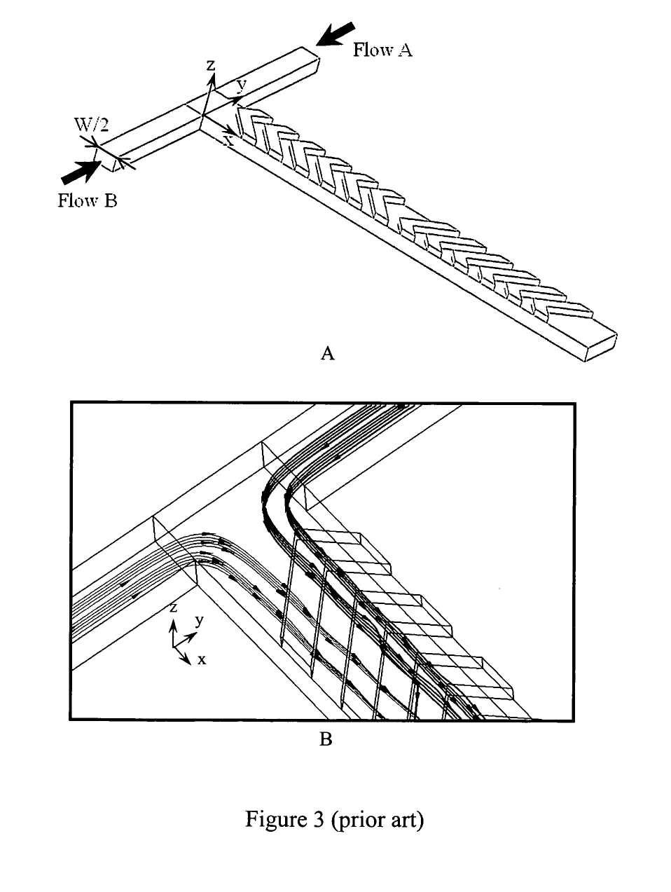

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

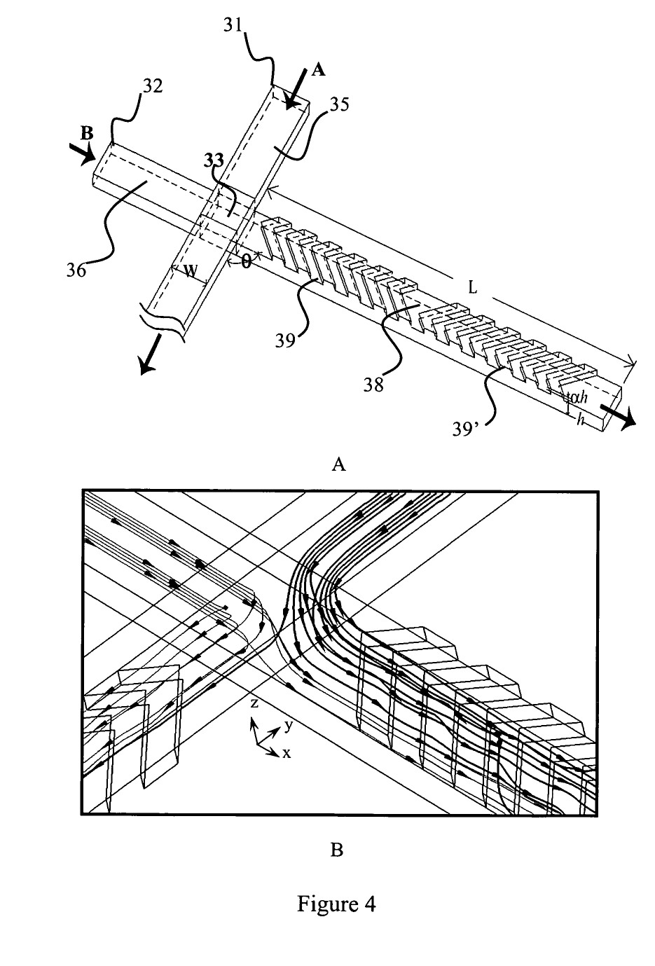

Refer to FIG. 4A, which is a schematic diagram illustrating the micromixer with overlapping-crisscross entrance according to an embodiment of the present invention.

This present invention consists of two straight, grooved microchannels crossing each other face to face in a tiny area at an angle from 0 to 180 degrees. The construction of the present invention is symmetric with respect to the contact surface between two microchannels. The transverse and longitudinal microchannels 31,32 containing fluids A and B respectively are in contact and mix across a small area 33. The width of each microchannels is about 5 μm to 500 μm and has one inlet and one outlet, wherein the aspect ratio is less than 1.

For detailed investigation of the characteristics of present invention each microchannel has two parts—the inlet ports 33, 35, 36 and mixing channel 38. The inlet ports 33,35,36 begin from the entrance of the microfluidics device to the end at which two inlet fluids merge. The mixing channel 38 is the region downstream from the inlet port. The longitudinal length L is 2046.6 μm; two microchannels intersect at an angle=90. The mixing channel 38 has a plurality of chevron-shaped grooves 39,39′ which is used for mixing two different fluids.

The three-dimension of present invention is numerically analyzed to reveal the velocity field and mixing characteristics of fluid streams. To formulate a mathematical description of mixing processes, some assumptions are proposed as follow. Two Newtonian fluids with constant density ρ, viscosity μ, diffusion coefficient D are selected. The flow is steady, incompressible and laminar with small Reynolds number (Re<<1), which signifies that the viscous force dominates and the inertial force is negligible. The body force is negligibly small and scarcely affects the simulation results. The governing equations hence become reduced to

$$\begin{matrix}continuity eqution : \frac{\partial {u}_{i}}{\partial {x}_{i}} = 0 & ( 1 ) \\ momentum equation : 0 = - \frac{\partial p}{\partial {x}_{i}} + \frac{\partial }{\partial {x}_{j}} [ μ ( \frac{\partial {u}_{i}}{\partial {x}_{j}} + \frac{\partial {u}_{j}}{\partial {x}_{i}} ) ] & ( 2 ) \\ species equation : {u}_{i} \frac{\partial c}{\partial {x}_{i}} = {D ( \frac{\partial c}{\partial {x}_{i}} )}^{2} & ( 3 )\end{matrix}$$

in which u, c and p denote velocity, concentration and pressure, respectively. These three equations are solved with a computational fluid dynamics (CFD) package (CFD-ACE), and are discretized with a finite-volume method. The SIMPLEC algorithm is adopted for pressure correction and the space variable is interpolated with a first-order upwind scheme, which is a highly stable scheme. Initial flow speeds and concentration in the inlet of flow A in the y-direction entrance and flow B in the x-direction are V=−0.83 μm/s, c=0, and U=0.83 μm/s, c=1, with Peclet number Pe=2×10⁵ and Reynolds number Re=0.01. No slip boundary conditions are prescribed.

To obtain accurate simulation results, during preprocessing a structured mesh of hexahedral elements of high quality is built. Intensive elements are established near the inlet port and the mixing channel, at which a strong interaction between the two fluids occurs. In these cases the total number of mesh elements is about 800,000.

A fabrication process with a multilayer pattern was adopted to build directly the laminated microstructures with standard photolithographic procedures; the membrane sandwich method is used for three-dimensional construction. Several patterned slabs are assembled one by one or sandwiched with two thicker flat covers using the membrane sandwich method. For a micromixer with a complicated structure, designing a fabrication process is typically a difficult step. Because the construction of present invention is symmetric with respect to the contact surface between microchannels, the sandwich method was used; hence the fabrication procedures for the present invention were significantly simplified.

Additionally, the cast molding is patterned with a photolithographic process using negative tone photoresist, such as SU-8 (MicroChem Corp.) or JSR (JSR Corp.). A replicate molding technology is then adopted to mold a poly-dimethylsiloxane (PDMS, SYLGARD 184 Silicone Elastomer, Dow Corning) or polymethymethacry-late (PMMA) prepolymer mixture into the microstructures of the present invention. Then the degassed mixture is poured onto the patterned cast and peels off the cured replicas. Finally, Teflon pipes are inserted into the access holes on the reservoirs to connect with a syringe pump.

The syringe pump was used to manoeuvre the inlet conditions of the present invention. The mixing fluids were pressure-driven into the reservoirs with Teflon tubes (i.d. 0.46 mm, o.d. 0.92 mm) and disposable syringes (1 mL, with 25-gauge needles). Aqueous dye liquor was mixed and filtered with food pigment (Daiwa Dyestuff Mfg. Co., Ltd.) and deionized water. The images of the flow field with an inverted microscope (Leica) and an assembled digital camera are captured.

Refer to FIG. 4B, which is vertical distributed streaklines of flow patterns according to an embodiment of the present invention.

The horizontal distribution of the streaklines in z=±0.6 μm of the present invention reveals noticeable transverse advection of two fluids, which overcomes the drawback of slight mixing in the inlet port of many existing micromixers.

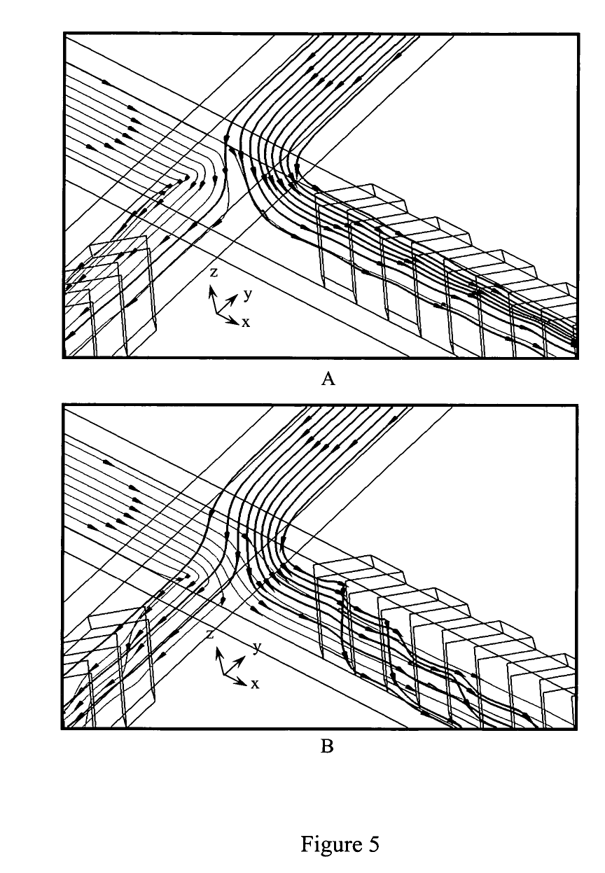

Refer to FIGS. 5A and 5B, which are row streaklines of the upper streams and lower streams according to an embodiment of the present invention.

The diverting fluids are dispersed near the downstream region of the transverse microchannel, where there is less flow resistance. The well diffusion occurs with lₘ=h/2 in present invention, in which lₘ is proportional to the square root of the mixing interval (T) multiplied by the diffusion coefficient; i.e., lₘ˜^{\sqrt{Dτ}}. The decrease in lₘ also significantly decreases the mixing length Δyₘ of present invention.

A ratio of initial volumetric flow rate between the y-direction and x-direction upstream, ^{Q}^{_{ty}}^{/Q}^{ᵢₛ}, decreases proportionally to the ratio of mass flow rates of separate streams in the x-direction mixing microchannel, ^{\dot{m}}^{ᵢ}^{/\dot{m}}^{₁}. This approach proves to be an excellent method to manipulate flow mixing between two fluids and is potentially extensible to be an active micromixer.

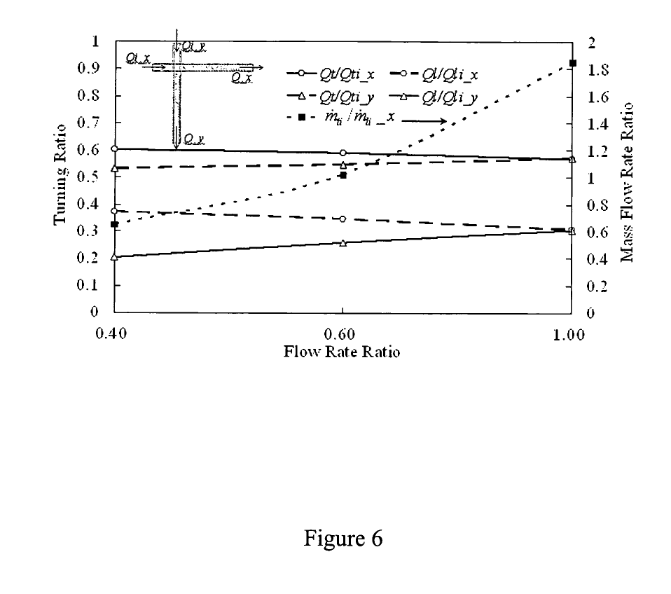

Refer to FIGS. 6, which is turning ratios and mass flow rate ratios versus various initial flow rate ratios according to an embodiment of the present invention.

The turning ratio is defined as the ratio of the diverted flow rate to the initial flow rate upstream from the crisscross. In this work the turning ratios of the x-direction stream range between 0.3 and 0.6, whereas those of the y-direction stream are between 0.2 and 0.57. The ratio is modulated by the aspect ratio of each channel and varies from 0 to 1.

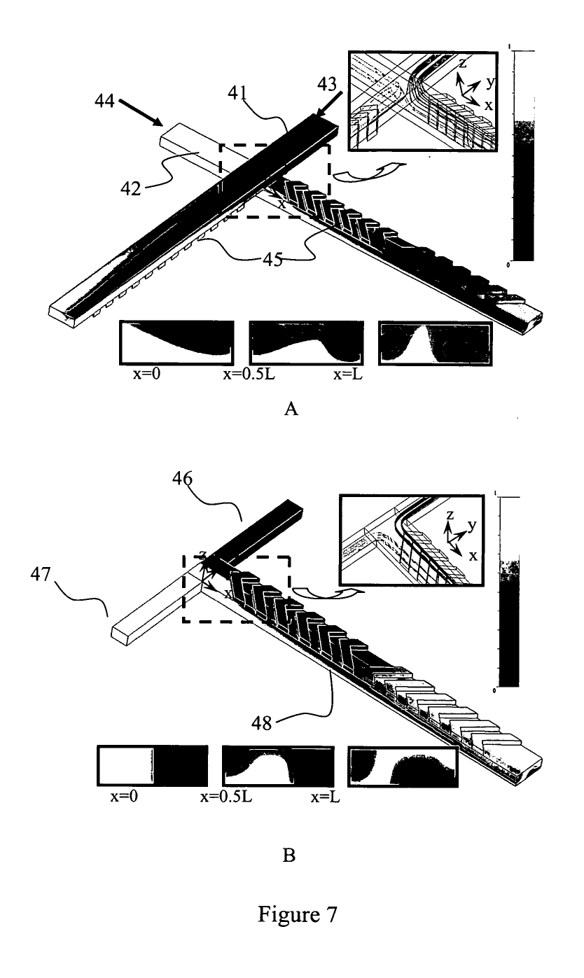

Refer to FIGS. 7A and 7B, which are bulk concentration contours according to an embodiment of the present invention and the staggered herringbone mixer.

By virtue of the asymmetric grooved patterns, the turning fluid streams near the short oblique ridges produce a refilling of the first half cycle of the grooves, where the flow resistance is less in a direction parallel to the patterned structures. In contrast the mixing in the staggered herringbone mixer (SHM) shows that the SHM is negligible before the first groove.

For the cross sections near the entrance, the fluids within the SHM are separated transversely, whereas mixing within the present invention is mainly in the vertical direction, but mixing in the transverse direction also proceeds. Hence the dissimilar flow configurations of the mixing channels are demonstrated. At 990 μm (0.5L) downstream, which corresponds to half a cycle of the patterned distribution, fluid A begins to roll over fluid B counter clockwise. The advection between the last half a cycle of the present invention significantly enhances the extent of mixing. The streaklines reveal that the mixing in the SHM is transverse, whereas in the present invention it is vertical and more pronounced.

To analyze quantitatively the mixing performance of the two micromixers, we adopt a mixing index as follows,

$$mixing index = 1 - \sqrt{\frac{{σ}^{2}}{{σ}_{max}^{2}}}$$

in σ which is the standard deviation of the concentration across the cross section of the channel at any specific longitudinal location, and σₘₐₓ is the maximum standard deviation (unmixed at the inlet). A smaller standard deviation signifies a greater mixing index, which indicates superior mixing. The value of this mixing index is 0 for completely segregated streams for which σ²=σₘₐₓ², and 1 for completely mixed streams for which σ²=0.

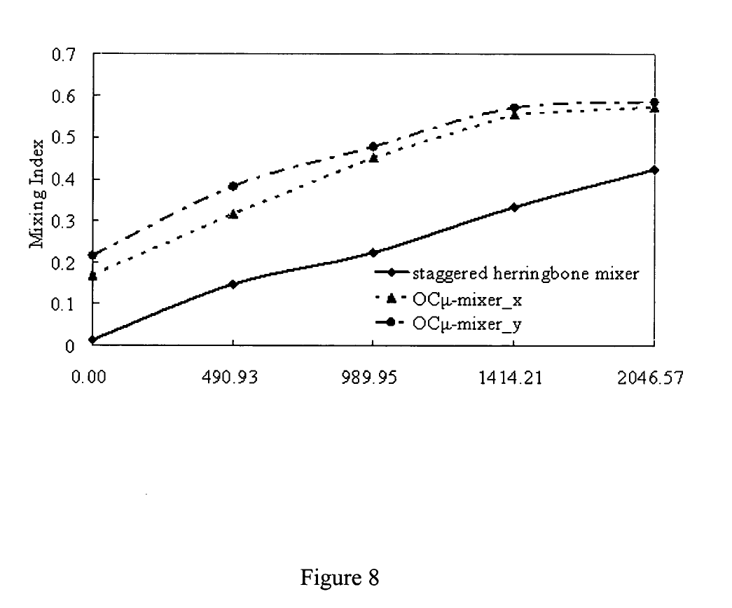

Refer to FIG. 8, which is mixing indexes at various longitudinal distances of x-direction and y-direction channels according to the SHM and an embodiment of the present invention.

The mixing indexes vary every quarter cycle (495 μm) because the grooved pattern alters periodically every 990 μm. The mixing indexes of the crisscross micromixer vary from 0.2 to 0.6 as the longitudinal distance increases from 0 to 2000 μm. The same indices are counted to 0-0.4 for the staggered herringbone mixer. The initial jump of the present invention indicates the effects from the overlapping crisscross entrance, where there is great advection between mixing fluids. In addition, the slope of the mixing index is greater for the present invention than for the staggered herringbone mixer. The flow structure amended by the proposed entrance design is evidently well suited for the patterned groove mixing channel.

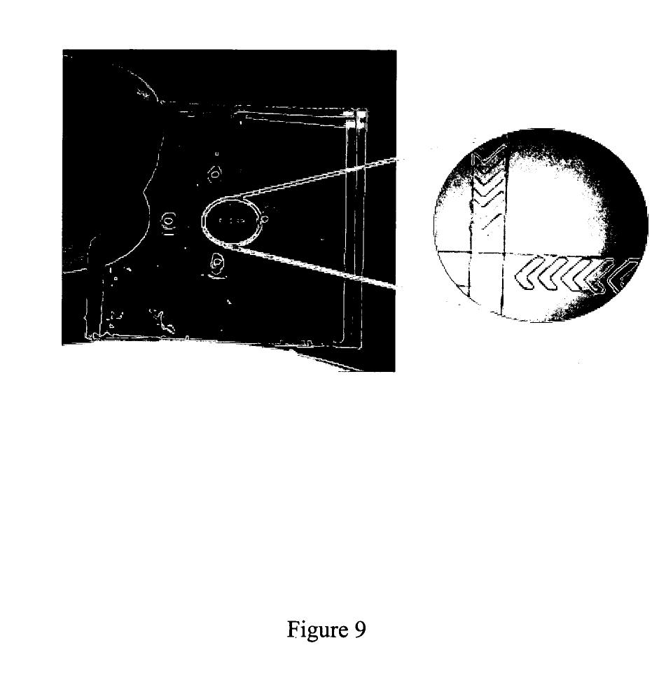

Refer to FIGS. 9, which is the magnified image of the grooves according to FIGS. 7A.

Fluid A enters from reservoir and leaves through outlet and the other tangential outlet, which is at a direction parallel to the sequence of grooves.

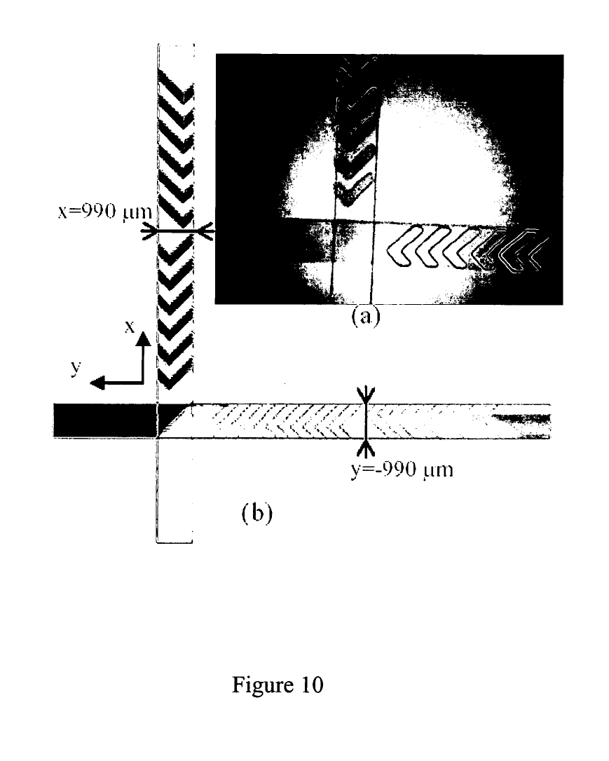

Refer to FIGS. 10, which is an experimental image of concentration contour on cross sections along the z-axis according to an embodiment of the present invention.

The image shows a significant cross flow near the inlet port and similar downstream flow configurations. Similar flow patterns between z=±35 μm and z=±69.7 μm indicate satisfactory agreement of mixing performance between x-direction and y-direction mixing channels.

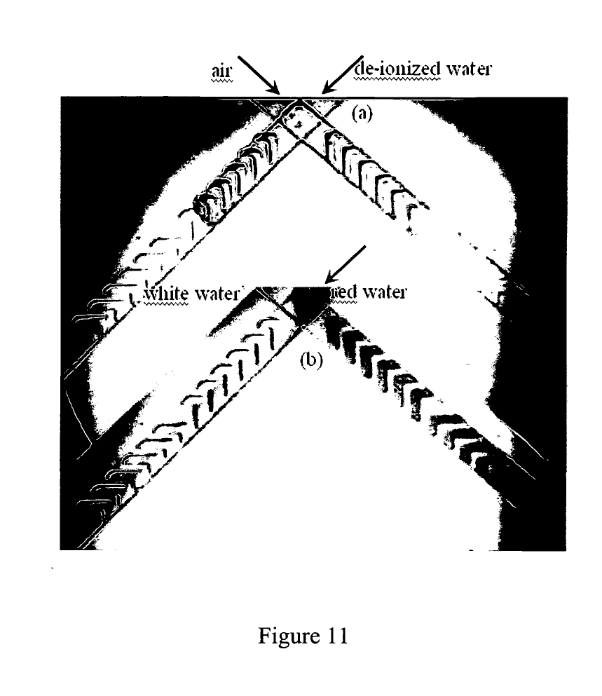

Refer to FIGS. 11, which is an experimental image of flow visualization of mixing between (a) air and de-ionized water and (b) red and white water according to an embodiment of the present invention.

Mixing fluids of air and deionized water demonstrate the fluid separation as a result of the effects of the overlapping crisscross entrance. By virtue of the reverse distributions between the mixing fluids after flowing into the entrance of the mixing channels, the reverse flow arrangement between red and white water is also displayed.

The detailed results of velocity distributions and streaklines reveal that the overlapping crisscross entrance enlarges the contact area between the two mixing fluids and induces tumbling to generate a vertical component of flow. A significant crossflow is developed about the inlet port of the micromixer and activates a restructuring of the flow configuration and mixing patterns in the grooved channels, for which the visual images of our experiments also reveal similar consequences.

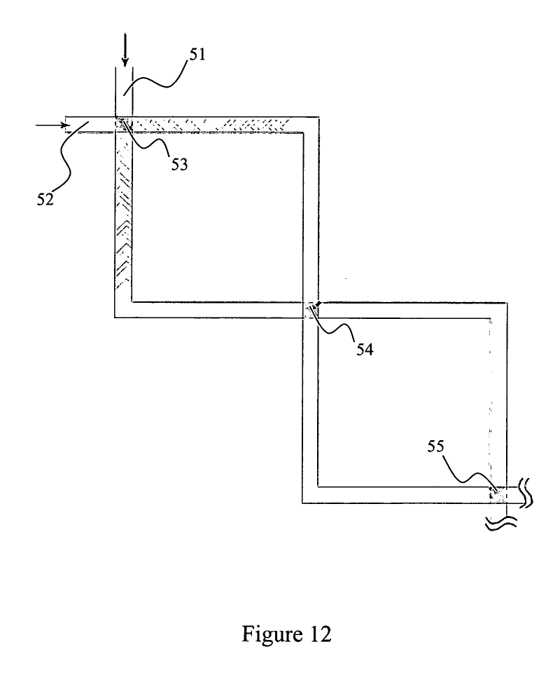

Refer to FIG. 12, which is a schematic diagram according an embodiment of the present invention.

The shape of microchannels 51,52 is saw-toothed, wherein the special patterns are grooved in the wall of mixing channels. Two microchannels 51,52 of same structure repetitively overlap each other in a series of symmetry at angle θ. The present invention combines the overlapping crisscrossed mechanism provides transversal momentum and the groove infrastructure offers fluid spiral momentum, which connected in series has some nodes 53, 54, 55 made by way of contacting on periodic exchange and enhances folding and stretching effect in those nodes 53, 54, 55. The advantage of this invention is not only having good mixing efficiency, but also easy for fabrication. Because upper and lower fluids of laminar are symmetrical with each other at angle θ, the present invention can make two same flow channels at the same time.

Modulating the ratios of initial flow rates generates varied ratios of rates of mass flow between the two fluid streams in the mixing chamber. The present invention hence achieves an excellent manipulation of flow mixing between two fluids and is possibly extensible to become a satisfactory active micromixer. Comparison of the mixing performance of this novel micromixer indicates that the mixing index ranges from 0.2-0.6 for the present invention and is 0-0.4 for the staggered herringbone micromixer.

Obviously, many variations can be made to the above example. For example, the content, number of users, providers, content location, etc. can be changed or adapted according to requirements.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A micromixer with overlapping-crisscross entrance, comprising:
a substrate; and
two microchannels overlapping and crossing each other face to face at an angle in an area of said substrate, wherein an entrance resides in said area, and each said microchannel comprising:
an inlet port for separating two different fluids and for mixing two said fluids at said entrance; and
an mixing channel comprising a plurality of grooves formed in said mixing channel wall, and used for mixing two said different fluids therein.

2. The micromixer with overlapping-crisscross entrance of claim 1, wherein said mixing channel at least has one patterned groove in a wall thereof.

3. The micromixer with overlapping-crisscross entrance of claim 1, wherein said angle is about 0 to 180 degrees.

4. The micromixer with overlapping-crisscross entrance of claim 1, wherein said angle is 90 degrees.

5. The micromixer with overlapping-crisscross entrance of claim 1, wherein the width of each said microchannel is about 5 μm to about 500 μm.

6. The micromixer with overlapping-crisscross entrance of claim 1, wherein an aspect ratio of each said microchannel is less than 1.

7. The micromixer with overlapping-crisscross entrance of claim 1, wherein the substrate comprises a negative tone photoresist, a polydimethylsiloxan (PDMS) and a polymethymethacrylate (PMMA).

8. The micromixer with overlapping-crisscross entrance of claim 7, wherein the negative tone photoresist is selected from SU-8 produced by MicroChem Corp. and JSR produced by JSR Corp.

9. The micromixer with overlapping-crisscross entrance of claim 1, wherein said two different fluids both have the Reynolds number smaller than 1.

10. The micromixer with overlapping-crisscross entrance of claim 1, wherein each said microchannel has one inlet and one outlet.
